(19) United States
(12) Patent Application Publication
(10) Pub. No.: US 2007/0266041 A1
(43) Pub. Date: Nov. 15, 2007

(54) CONCEPT OF RELATIONSHIPSETS IN ENTITY DATA MODEL (EDM)

(75) Inventors: Brian C. Beckman, Newcastle, WA (US); Kawarjit Singh Bedi, Sammamish, WA (US); Jose A. Blakeley, Redmond, WA (US); Anil Kumar Nori, Redmond, WA (US); Subramanian Muralidhar, Bellevue, WA (US); Benjamin Albahari, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/468,008

(22) Filed: Aug. 29, 2006

Related U.S. Application Data
(63) Continuation of application No. 60/747,071, filed on May 11, 2006.

(51) Int. Cl. G06F 17/30; G06F 7/00

(52) U.S. Cl. 707/102; 707/8

(57) ABSTRACT

The claimed subject matter provides a system and/or a method that facilitates addressing complex modeling. An entity data model that can receive data via an interface and that formalizes a notion of at least one of a Relationship, a Relationship instance, and a Relationship Set in a manner substantially similar to at least one of an Entity type, an Entity instance, and an entity-set respectively, wherein a semantic related to the at least one of the Relationship, the Relationship instance, and the Relationship Set are captured as metadata in the same manner as metadata is captured for at least one of the Entity type, the Entity instance, and the Entity-set, respectively.

### CROSS-REFERENCE TO RELATED APPLICATIONS

This application claims the benefit of U.S. Provisional Patent Application Ser. No. 60/747,071 filed on May 11, 2006, entitled “THE CONCEPT OF RELATIONSHIPSETS IN ENTITY DATA MODEL (EDM).” This application is related to pending U.S. patent application Ser. No. 11/171,905 entitled “PLATFORM FOR DATA SERVICES ACROSS DISPARATE APPLICATION FRAMEWORKS” filed on Jun. 30, 2005, U.S. patent application Ser. No. 11/195,320 entitled “STORAGE API FOR A COMMON DATA PLATFORM” filed on Aug. 2, 2005, and U.S. patent application Ser. No. 11/228,731 entitled “DATA MODEL FOR OBJECT-RELATIONAL DATA” filed on Sep. 16, 2005. The entireties of the above-noted applications are incorporated by reference herein.

### BACKGROUND

Data has become an important asset in almost every application, whether it is a Line-of-Business (LOB) application utilized for browsing products and generating orders, or a Personal Information Management (PIM) application used for scheduling a meeting between people. Applications perform both data access/manipulation and data management operations on the application data. Typical application operations query a collection of data, fetch the result set, execute some application logic that changes the state of the data, and finally, persist the data to the storage medium.

Traditionally, client/server applications relegated the query and persistence actions to database management systems (DBMS), deployed in the data tier. If there is data-centric logic, it is coded as stored procedures in the database system. The database system operated on data in terms of tables and rows, and the application, in the application tier, operated on the data in terms of programming language objects (e.g. Classes and Structs). The mismatch in data manipulation services (and mechanisms) in the application and the data tiers was tolerable in the client/server systems. However, with the advent of the web technology (and Service Oriented Architectures) and with wider acceptance of application servers, applications are becoming multi-tier, and more importantly, data is now present in every tier.

In such tiered application architectures, data is manipulated in multiple tiers. In addition, with hardware advances in addressability and large memories, more data is becoming memory resident. Applications are also dealing with different types of data such as objects, files, and XML (eXtensible Markup Language) data, for example.

In hardware and software environments, the need for rich data access and manipulation services well-integrated with the programming environments is increasing. One conventional implementation introduced to address the aforementioned problems is a data platform. The data platform provides a collection of services (mechanisms) for applications to access, manipulate, and manage data that is well integrated with the application programming environment. However, such conventional architecture falls short in many respects. Some key requirements for such a data platform include complex object modeling, rich relationships, the separation of logical and physical data abstractions, query rich data model concepts, active notifications, better integration with middle-tier infrastructure.

In particular, standard relational models do not recognize the notion of entities and relationships, but represent both of these in the same fashion- a relation or a table. Specifically, relationships are represented by foreign keys on one or both tables participating in the relationship and there is no separate table/relation to represent instance of the relationship. In some cases, however, for example in many-to-many relationships, link tables are used to model the relationships. Yet, problems still exist with the capabilities of distinguishing various natures of relationships.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate employing an entity data model that formalizes data. An entity data model can receive data via an interface (discussed infra), wherein such data can be formalized in a particular manner to facilitates addressing complex modeling needs. In particular, the entity data model can provide formalization of the notion of a Relationship type, a Relationship instance, and a RelationshipSet in a manner substantially similar to an entity type, an entity instance, and an entity-set respectively, wherein such formalization allows to reason about and manipulate Entities and Relationships with substantially similar techniques.

By providing the handling of relationship data similarly as entity data, the entity data model addresses the following: complex modeling needs; allows explicit and implicit relationships; and represents entities and relationships in a manner to recognize the notion and distinct nature of an entity and a relationship. Moreover, the treatment of RelationshipType data in a similar fashion as EntityType data facilitates navigation based on natural properties associated therewith without defining joints, link tables, joining conditions, etc. (e.g., discussed infra). Additionally, by utilizing a formalization technique similar to that of EntityType data for RelationshipType data, a foreign key, link table, etc. is not needed to reference, access, represent, model, and/or cross-reference such data. In other aspects of the claimed subject matter, methods are provided that facilitates employing an entity data model that formalizes a Relationship type, a Relationship instance, and a Relationship Set.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates employing an entity data model that formalizes data.

FIG. 2 illustrates a block diagram of an exemplary type structure in accordance with the claimed subject matter.

FIG. 3 illustrates a block diagram of an exemplary system that facilitates formalizing RelationshipType data in a manner that is analogous to EntityType data.

FIG. 4 illustrates a block diagram of an exemplary system that facilitates implementing a peer-to-peer relationship (association) and a parent-child relationship (containment).

FIG. 5 illustrates a block diagram of an exemplary system that facilitates navigating formalized data associated with an entity data model.

FIG. 6 illustrates a block diagram of an exemplary system that facilitates querying formalized data utilizing a query processor to provide a query result.

FIG. 7 illustrates a block diagram of an exemplary type structure describing the various cardinalities of type instances in accordance with the claimed subject matter.

FIG. 8 illustrates a block diagram of an exemplary system that facilitates formalizing the notion of at least one of a Relationship type, a Relationship instance, and a RelationshipSet.

FIG. 9 illustrates an exemplary methodology for employing an entity data model that formalizes a Relationship type, a Relationship instance, and a Relationship Set.

FIG. 10 illustrates an exemplary methodology that facilitates formalizing RelationshipType data in a manner that is analogous to EntityType data.

FIG. 11 illustrates an exemplary networking environment, wherein the novel aspects of the claimed subject matter can be employed.

FIG. 12 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “model,” “processor,” “entity,” “relationship,” and the like are intended to refer to a computer-related entity, either hardware, software (e.g. in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

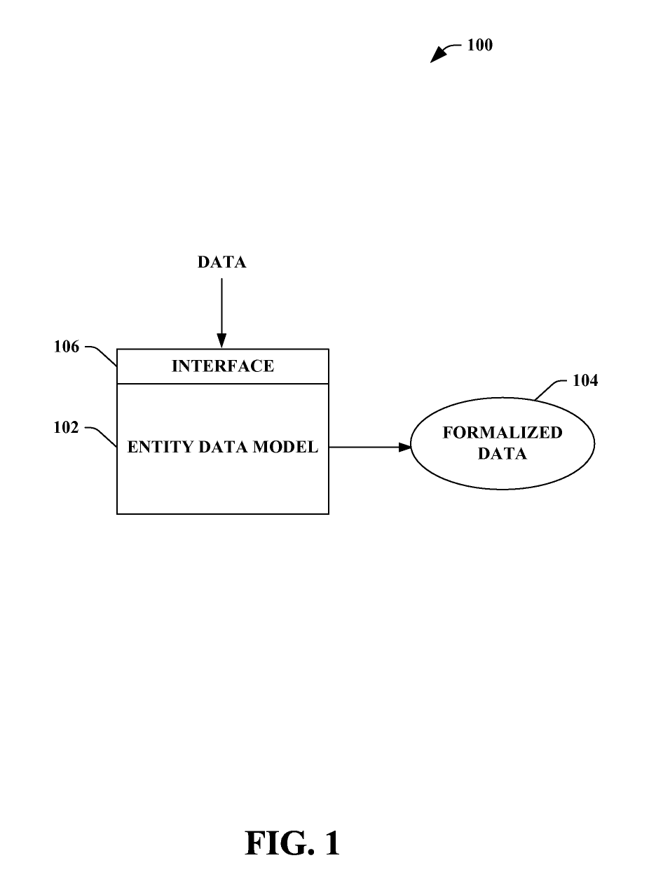

Now turning to the figures, FIG. 1 illustrates a system 100 that facilitates employing an entity data model that formalizes data. The system 100 can include an entity data model 102 that can receive data via an interface 106 (discussed infra), wherein such data can be formalized (referred to as formalized data 104) in a particular manner to facilitate addressing complex modeling needs. In particular, the entity data model 102 can provide formalization of the notion of a Relationship type, a Relationship instance, and a RelationshipSet in a manner substantially similar to an entity type, an entity instance, and an entity-set respectively, wherein such formalization allows to reason about and manipulate Entities and Relationships with substantially similar techniques. Thus, by providing the handling of relationship data similarly as entity data, the entity data model 102 addresses the following: complex modeling needs; allows explicit and implicit relationships; and represents entities and relationships in a disparate manner to recognize the notion and distinct nature of an entity and a relationship. Moreover, the treatment of RelationshipType data in a similar fashion as EntityType data facilitates navigation based on natural properties associated therewith without defining joints, link tables, joining conditions, etc. (e.g., discussed infra). Additionally, by utilizing a formalization technique similar to that of EntityType data for RelationshipType data, a foreign key, link table, etc. is not needed to reference, access, represent, model, and/or cross-reference such data.

In addition, the system 100 can include any suitable and/or necessary interface component 106 (herein referred to as “interface 106”), which provides various adapters, connectors, channels, communication paths, etc. to integrate the entity data model 102 into virtually any operating and/or database system(s) and/or with one another. In addition, the interface component 106 can provide various adapters, connectors, channels, communication paths, etc., that provide for interaction with at least one of the disparate component, system, machine, application, process, computer, etc.

The entity data model 102 (EDM) extends the basic relational model with concepts like support for rich types (with inheritance and polymorphism) and relationships. The entity data model 102 is intended to be a concrete conceptual model for a wide range of applications ranging from PIM (e.g. Personal Information Management) applications to Line-of-Business applications. In one example, the system can include a database runtime that implements the entity data model in a concrete manner, wherein the runtime includes at least one of the following: a mapping facility; a querying facility; and an updating facility that updates aat least one of an entity and a relationship in a data source.

The central concepts in the EDM 102 are entities and relationships. Entities describe real-world objects with independent existence, and are instances of Entity Types (e.g., Customer, Employee, book, shelf, keyboard, speaker, wall, house, street, globe, Earth, any suitable entity that can be a real-world object, etc.). An entity-set represents a collection of entities of the same entity type (e.g., Customers is a set of Customer instances, Employees is a set of Employee instances, etc.).

In most real-world applications, entities are related to other entities. The entity data model 102 provides first class support for this via the notion of Relationships. Relationships are instances of Relationship Types, and express linkages between instances of two or more entity types (e.g., Employee WorksFor Department, where Employee is an entity type, Department is an entity type, and WorksFor is the Relationship type). A RelationshipSet represents a collection of relationship instances of the same type (e.g., WorksFor, HiredBy, Contains, PlacesOneOrMore, IsAvailableFromOneOrMore, any suitable collection of verbs that can describe a relationship between two or more entities, etc.).

While the notion of a Relationship itself is a well-known data modeling construct, the formalization of the notion of Relationship types, Relationship instances and RelationshipSets—in a similar fashion to entity types, entity instances and entity sets—is a unique facet of the EDM 102; and helps to address complex modeling needs. This first-class treatment of Relationships in the EDM 102 enables mechanisms for both explicit and implicit relationships.

RelationshipSet—The entity data model 102 provides first class support for Relationships. Relationships are described by a Relationship type, and instances of the Relationship type describe relationships between the corresponding entity instances. The EDM 102 supports two kinds of relationships. Association relationships model peer-to-peer relationships between entities, while Containment relationships model parent-child relationships. In either case, the instances of the relationship are logically contained in a RelationshipSet (e.g. analogous to how entity instances are contained in an entity-set.).

A RelationshipSet contains relationship instances of the specified RelationshipType. The description of the RelationshipSet includes the EntitySet(s) that hold instances of the entity types that correspond to each end of the relationship type. More formally, for a given a RelationshipType (RT) that relates Entity Types ET1, ET2, . . . , EntitySets ES1, ES2, . . . that hold instances of ET1, ET2 . . . , a RelationshipSet RS for RT (scoped to ES1, ES2, . . . ) holds instances of RT that connect entity-instances in ES1, ES2, . . .

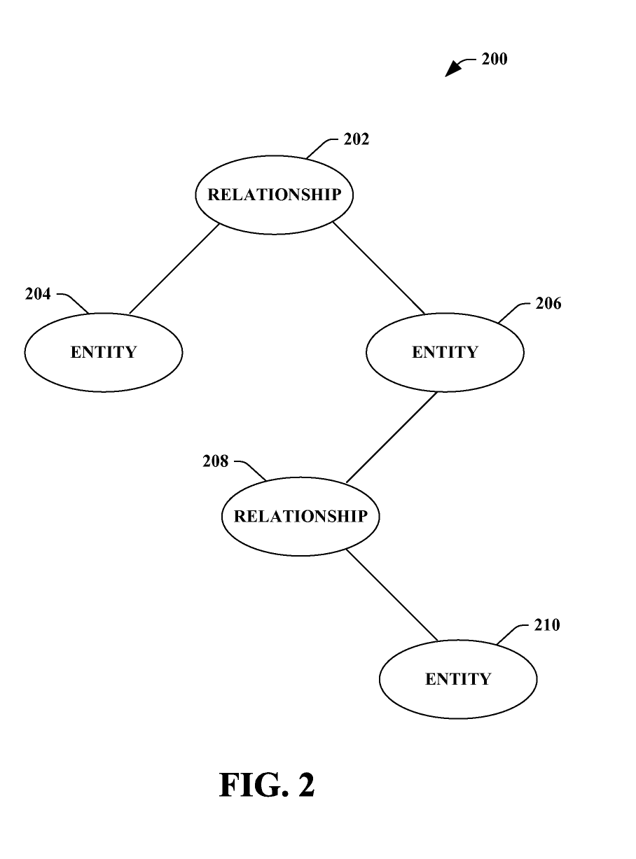

FIG. 2 illustrates a type structure 200 in accordance with the claimed subject matter. The type structure 200 is an exemplary type structure associated with the subject innovation including a particular configuration and structure including two EntityTypes and two RelationshipTypes, yet it is to be appreciated that such structure is not to be limiting on the claimed subject matter and any suitable number of EntityTypes and RelationshipTypes can be included in the type structure 200. The type structure 200 can include a RelationshipType 202 that expresses a linkage between an EntityType 204 and an EntityType 206, which in turn, addresses complex modeling needs. Moreover, numerous possibilities and/or combinations associated with RelationshipTypes and EntityTypes can be employed. As depicted in FIG. 2, the EntityType 206 can further be linked to an EntityType 210 by a RelationshipType 208. In other words, an EntityType can be associated with more than one RelationshipType, whereas a RelationshipType can provide a one-to-one linkage between at least two EntityTypes. Moreover, by utilizing a formalization technique similar to that of EntityType data for RelationshipType data, a foreign key, link table, etc. is not needed to reference, access, represent, model, and/or cross-reference such data.

An EntityType can define the principal data objects about which information has to be managed such as person, places, things or activities relevant to the application. An Entity can be an instance of an EntityType, wherein it can have a unique identity, independent existence, and forms the operational unit of consistency. In addition, an EntityType can have one or more properties of the specified SimpleType, ComplexType, or RowType. Properties can be either single-valued or multi-valued. Instances of an EntityType can be uniquely identified by the value of its identifying properties. This set of identifying properties can be referred to as an EntityKey. A ComplexType can represent a set of related information. Similar to EntityType, it consists of one or more properties of SimpleType, ComplexType, or RowType. However unlike EntityType, ComplexType is not associated with an EntityKey. RowType can be an anonymous type that is structurally similar to ComplexType except that it cannot participate in type-inheritance. Two (anonymous) RowType instances are comparable if their corresponding RowTypes have the same number, sequence and type of properties. While EntityTypes are like nouns of a data model, RelationshipTypes are the verbs that connect those nouns. A RelationshipType can be described over two or more participating EntityTypes. The EDM 102 supports two kinds of RelationshipTypes, Association and Containment. An Association is like a peer-to-peer relationship while Containment is a parent-child relationship with specific membership semantics. EDM types can be contained within some namespace. The Schema concept defines a namespace that describes the scope of EDM types.

An EntitySet for an EntityType holds instances of its EntityType or any of its subtypes. Multiple EntitySets may be defined for a given EntityType. A RelationshipSet for a given relationship type may hold instances of that type. The relationship instance connects entity instances contained by the EntitySets participating in this RelationshipSet. A RelationshipSet description includes the RelationshipType and the corresponding EntitySets of the EntityTypes described in RelationshipType. EDM instance-based concepts like EntitySets and RelationshipSets are defined in the scope of an EntityContainer. Users can have one or more instances of EntityContainer. An EntityContainer can reference one or more Schemas.

The following examples are for the sole purpose of illustrating the various linkage and/or connection between various EntityTypes and RelationshipTypes and such examples are not to be limiting on the claimed subject matter. For instance, the EntityType 204 can be defined and named “SalesPerson” and the EntityType 206 can be defined and named “Automobile,” while the RelationshipType 202 can be defined and named “Sells.” Following the same example, the EntityType 210 can be defined and named “AutomobileCompany,” while the RelationshipType 208 can be defined and named “IsManufacturedBy.” Thus, the following is described by the type structure 200: the SalesPerson type “Sells” Automobile type and Automobile type “IsManufacturedBy” AutomobileCompany type. In addition, it is to be appreciated and understood that the RelationshipType 202 is an AssociationType, while the RelationshipType 208 is a ContainmentType (discussed generally supra, and in more detail infra).

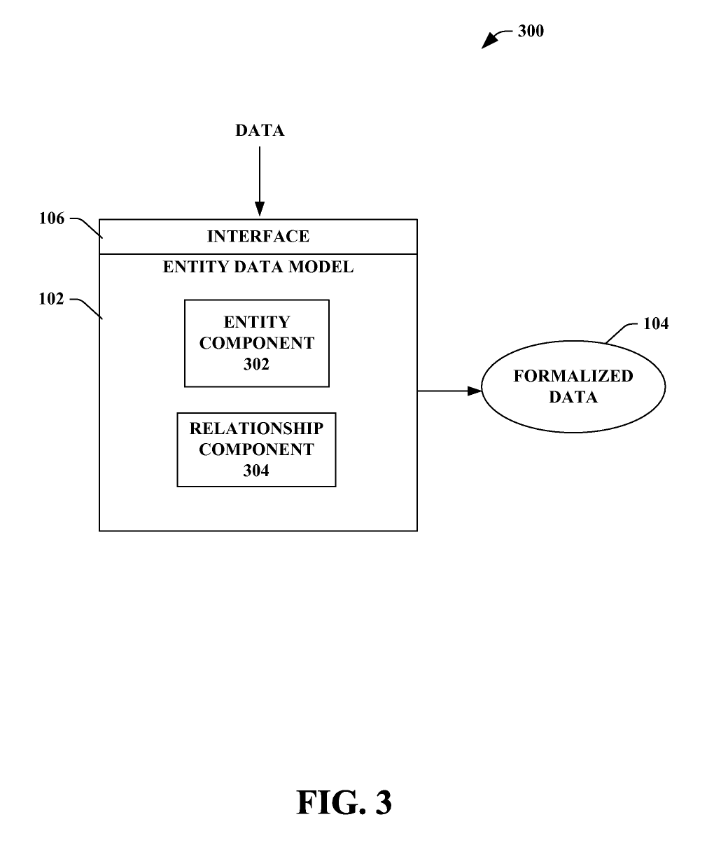

FIG. 3 illustrates a system 300 that facilitates formalizing RelationshipType data in a manner that is analogous to EntityType data. The system 300 includes the entity data model 102 that facilitates formalizing data which provides support for rich types (e.g., with inheritance and polymorphism) and relationships. In other words, the entity data model 102 can employ formalized data 104, wherein such formalization of data received (via the interface 106) such as RelationshipType data (e.g., Relationship Types, Relationship Instances, Relationship Sets, etc.) can be formalized in an analogous manner such as EntityType data (e.g., Entity Types, Entity Instances, Entity Sets, etc.) is formalized. It is to be appreciated that such treatment of Relationship data enables mechanisms for at least one of explicit and implicit relationships. Moreover, by utilizing a formalization technique similar to that of EntityType data for RelationshipType data, a foreign key, link table, etc. is not needed to reference, access, represent, model, and/or cross-reference such data.

The entity data model 102 can include an entity component 302 that can facilitates implementing and/or formalizing EntityType data in accordance with the subject innovation. An Entity is an instance of an EntityType. It has a unique identity, independent existence and forms the operational unit of consistency. Intuitively, EntityTypes model the “top-level” concepts within a data model—such as Customers, Orders, Suppliers, etc. (to take the example of a typical line-of-business system). An Entity-instance represents one particular instance of the EntityType such as a specific customer or a specific order. An EntityType can be either abstract or concrete where the former cannot have instances. An EntitySet can contain a set of entity instances of a specified entity type. An EntitySet's type can be either abstract or concrete and can contain instances of the same or any of its derived concrete entity type. The EntitySet can contain any entity instance that satisfies the following: its type is either the same as EntitySet's type or any of its derived type; it is not a member of any other EntitySet; and its key value uniquely identifies it in the EntitySet. An EntityType has a name, a payload consisting of one or more properties and an EntityKey that describes the set of properties, values of which uniquely identify the instance of an entity within an entity set. The type of a property can be a primitiveType, enumerationType, complexType, or a rowType.

The entity data model 102 can further include a relationship component 304 that facilitates handling and/or formalizing RelationshipType data. While entity types are the nouns of a data model, relationships are the verbs that connect those nouns. A relationship denotes a connection (e.g., a relation, a link, etc.) between two or more Entities. An example of relationship would be: A customer places one or more orders, an order contains order details, a product is available from on or more suppliers, and so on and so forth. In these sentences, entities are in italics and relationships are underlined. The relationship concept is borrowed from the classic Entity-Relation data model and made a first-class concept in the entity data model 102. A relationshipSet contains relationship instances of the specified RelationshipType. A relationship instance connects two or more entity instances belonging to the EntitySet(s) associated with the RelationshipSet. The RelationshipSet description includes EntitySet(s) that can hold instances of EntityTypes that its RelationshipType connects. Each RelationshipType kind has its corresponding RelationshipSet.

It is to be appreciated that the following is solely utilized as an example and the claimed subject matter is not to be so limited. The following pseudo code example illustrates an entity data model data definition fragment defining three entity types Product Category, and DiscontinuedProduct; an association relationship type CategoryProduct; and an entity container NorthwindContainer containing two entitysets Products and categories and a relationship set CategoryProducts.

```
<?xml version=“1.0” encoding=“utf-8”?>
<Schema Namespace=“EDM.Samples.Northwind”
xmlns=“urn:schemas:storage”>
  <EntityContainerType Name=“NorthwindContainer”>
  <!-- EntitySet definitions -->
  <Property Name=“Products”  Type=“EntitySet(Product)” />
  <Property Name=“Categories”  Type=“EntitySet(Category)” />
  <!-- RelationshipSet for CategoryProducts -->
  <Property Name=“CategoryProducts”
Type=“RelationshipSet(CategoryProduct)”>
    <End Name=“Category”  Extent=“Categories” />
    <End Name=“Product”  Extent=“Products” />
  </Property>
  </EntityContainerType>
  <!-- Entity type definitions -->
  <EntityType Name=“Product” Key=“ProductID”>
  <Property Name=“ProductID”  Type=“System.Int32”
Nullable=“false”/>
  <Property Name=“ProductName”  Type=“System.String”
  Size=“256”/>
  <Property Name=“QuantityPerUnit”  Type=“System.String”
  Size=“256”/>
  <Property Name=“UnitPrice”  Type=“System.Decimal” />
  <Property Name=“UnitsInStock”  Type=“System.Int16” />
  <Property Name=“UnitsOnOrder”  Type=“System.Int16” />
  <Property Name=“ReorderLevel”  Type=“System.Int16” />
  </EntityType>
  <EntityType Name=“Category” Key=“CategoryID”>
  <Property Name=“CategoryID”  Type=“System.Int32”
Nullable=“false” />
  <Property Name=“CategoryName”  Type=“System.String”
Size=“256” />
  <Property Name=“CategoryDescription”  Type=“System.String”
Size=“256”/>
  </EntityType>
  <EntityType Name=“DiscontinuedProduct” BaseType=“Product”>
  </EntityType>
  <Association Name=“CategoryProduct”>
  <End Name=“Category”  Type=“Category” Multiplicity=“1” />
  <End Name=“Product”  Type=“Product”  Multiplicity=“*”
PluralName=“Products” />
  </Association>
</Schema>
```

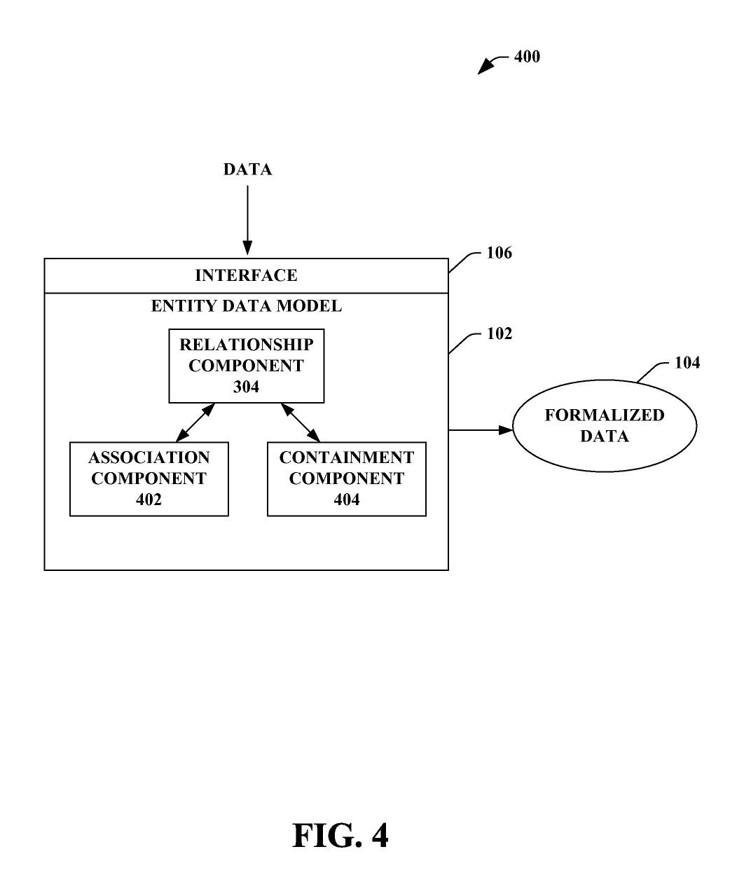

FIG. 4 illustrates a system 400 that facilitates implementing a peer-to-peer relationship and a parent-child relationship. The system 400 can include the entity data model 102 that can provide formalized data 104 in association with RelationshipType data in a manner analogous to EntityType data allowing complex modeling needs to be met. Moreover, such treatment of RelationshipType data (e.g., formalization of data in a manner substantially similar to EntityType data) allows support for inheritance and polymorphism.

The entity data model 102 and in turn, the relationship component 304 can support two kinds of relationships, an Association relationship and a Containment relationship. The relationship component 304 (e.g., which can handle any data associated with RelationshipTypes and discussed supra) can further utilize an association component 402. The association component 402 can utilize and/or handle any data related to an Association relationship (e.g., Association element, AssociationSet, AssociationType, any suitable data related to Association, etc.), wherein such relationship models a peer-to-peer relationship between at least two entities. The Association relationship is a common and general-purpose relationship. The Association relationship can define peer-to-peer relationships between participating entity-types and can support any multiplicity at either end. The OnDelete operational behavior can be specified at any end of the relationship.

A classic example of an association is the relationship between the Customer and Order entities. Typically, this relationship has the following characteristics: 1) Multiplicity—each Order is associated with exactly one Customer and every Customer has zero or more Orders; 2) Operational Behavior—OnDelete Cascade; when an Order with one or more OrderLines is deleted the corresponding OrderLines(s) also get deleted.

The system 400 can utilize the <Association> element to create this relationship, as shown below:

```
<Association Name=”CustomerOrder”>
  <End Type=”Customer” Multiplicity=”1” role=”Orders” >
    <OnDelete Action=”Cascade” />
  </End>
      <End Type=”Order” Multiplicity=”*” role=”OrderedBy” />
</Association>
```

The <Association> element in line 1 defines the CustomerOrder relationship between Customer and Order EntityType. The abstract syntax for describing Association relationship is shown below:

AssociationType ::= ASSOCIATION associationName (EndDescription
EndDescription)
EndDescription ::= ENTITYTYPE entityTypeName [ROLE roleName]
MULTIPLICITY (0..1 | 1 | *| 1..* | n | n..m) [Operation]*
Operation ::= ONDELETE (CASCADE| RESTRICT |
REMOVEASSOCIATION)

AssociationSet—An AssociationSet contains relationship-instances of the specified AssociationType. The AssociationType specifies the EntityTypes of the two end points while AssociationSet specifies the EntitySets that correspond to these EntityTypes. The association-instances contained in the AssociationSet relate entity-instances belonging to these EntitySets.

The following SDL example demonstrates the usage of AssociationSet:

### EXAMPLE

1. <EntityType Name=“Customer” Key=“CustomerId”>
2. ...
3. </EntityType>
4. <EntityType Name=“Order” Key=“OrderId”>
5. ...
6. </EntityType>
7. <Association Name=”CustomerOrderType”>
8. <End Type=”Customer” Multiplicity=”1” Role=”OrderedBy” />
9. <End Type=”Order” Multiplicity=”*” Role=”Orders” />
10. </Association>
11.
12. <EntitySet Name=“CustomerSet” EntityType=”Customer”/>
13.
14. <EntitySet Name=“OrderSet” EntityType=”Order”/>
15.
16. <AssociationSet Name=“CustomerOrderSet”
Association=”CustomerOrderType”>
17. <End EntitySet=”CustomerSet”/>
18. <End EntitySet=”OrderSet”/>
19. </AssociationSet >

Lines 1-6 describe creation of EntityTypes “Customer” and “Order”. Line 7 defines AssociationType “CustomerOrderType”. Lines 8-9 create and define RelationshipTypes “OrderedBy” and “Orders.” Lines 12 to 14 describe creation of EntitySet “CustomerSet” and “OrderSet”. The <AssociationSet>element on line 16 defines AssociationSet named “CustomerOrderSet” of type “CustomerOrderType” defined on line 7 above. The two EntitySets corresponding to the AssociationType-end EntityTypes are specified on line 17 and 18. The association instances will live in CustomerOrderSet and connect instances in CustomerSet and OrderSet.

The abstract syntax for describing AssociationSet is shown below:

AssociationSet ::= ASSOCIATIONSET assocSetName TYPE assocType
{EndDescription EndDescription}
EndDescription ::= END ENTITYSET entitySetName

A containment component 404 can utilize and/or handle any data related to a Containment relationship (e.g. Containment element, ContainmentSet, ContainmentType, any suitable data related to Containment, etc.), wherein such relationship models a parent-child relationship. Containment relationships can have the following characteristics:
Direction: The containment relationship is a bi-directional relationship with different semantics for each direction of the relationship.
Multiplicity: This relationship is 1 to 0 . . . N where the cardinality of one end is 1. For convenience, the 1-end can be referred to as the parent, and the other end as the child.
Exclusive membership constraint: A child entity-type may participate in multiple Containment relationships however a child entity-instance can be a member of exactly one Containment relationship-instance. In other words, a child entity-instance at all times is contained in exactly one parent entity-instance.
Operational Behavior: A Containment child entity-instance lives in the scope of its parent entity-instance. As a result the Action on OnDelete operation is restricted to be Cascade or Restrict with Cascade as the default.

The following example shows the definition of a Containment relationship:

<Containment Name=”Parent_Child”>
<End Type=”Parent” role=”Parent” />
<End Type=”Child” Multiplicity=”*” role=”Children” />
</Containment>

### The <Containment> element in line 1 defines the Parent_Child relationship between Parent and Child EntityType.

The abstract syntax for describing Containment relationship is shown below:

ContainmentType ::= CONTAINMENT containmentName (ParentEnd,
ChildEnd)
ParentEnd ::= PARENT entityTypeName [ROLE roleName]
[Operation]
ChildEnd ::= CHILD entityTypeName [ROLE roleName] [
MULTIPLICITY (0..1 | 1 | * | 1..* | n | n..m) ]
Operation ::= ONDELETE (CASCADE | RESTRICT)

ContainmentSet—A ContainmentSet contains relationship-instances of the specified ContainmentType. The ContainmentType specifies the EntityTypes of the parent and child ends while ContainmentSet specifies the EntitySets that contain instances of these EntityTypes. The Containment instances contained in the ContainmentSet relate entity-instances belonging to these EntitySets.

The following SDL example demonstrates the usage of ContainmentSet:

### EXAMPLE

```
1.  <EntityType Name=“Organization” Key=“Id”>
2.  ...
3.  </EntityType>
4.  <EntityType Name=“Department” Key=“Id”>
5.  ...
6.  </EntityType>
7.
8.  <Containment Name=”OrgHasDeptType”>
9.  <Parent Type=”Organization” Name=”HasDept” />
10.  <Child Type=”Department” Multiplicity=”*”
      Name=”ContainedBy” />
11.  </Containment>
12.  <Containment Name=”DeptHasDeptType”>
13.  <Parent Type=”Department” />
14.  <Child Type=”Department” Multiplicity=”*”
      Name=”ContainedBy” />
15.  </Containment>
16.
17.  <EntitySet Name=“OrganizationSet”
      EntityType=”Organization”/>
18.  <EntitySet Name=“DepartmentSet” EntityType=”Department”/>
19.
20.  <ContainmentSet Name=“OrgHasDeptSet”
21.  Containment=”OrgHasDeptType”>
22.  <Parent EntitySet=”OrganizationSet” />
23.  <Child EntitySet=”DepartmentSet” />
24.  </ContainmentSet>
25.  <ContainmentSet Name=“DeptHasDeptSet”
26.  Containment=”DeptHasDeptType”>
27.  <Parent EntitySet=”DepartmentSet” />
28.  <Child EntitySet=”DepartmentSet” />
29.  </ContainmentSet>
```

Lines 1-6 describe creation of EntityTypes “Organization” and “Department.” Lines 8-16 define ContainmentTypes “OrgHasDeptType” and “DeptHasDeptType.” Lines 17 to 19 describe the creation of EntitySet “OrganizationSet” and “DepartmentSet.” The <ContainmentSet> element on line 20 defines ContainmentSet named “OrgHasDeptSet” of type “OrgHasDeptType” defined on line 8 above. The two EntitySets corresponding to the parent and child EntityTypes for ContainmentType are specified on line 21 and 22. Lines 25-28 describe another ContainmentSet “DeptHasDeptSet” over the same EntitySets but different ContainmentType.

The abstract syntax for describing ContainmentSet is shown below:

ContainmentSet ::= CONTAINMENTSET name TYPE
containmentTypeName
{ Parent Child }
Parent ::= PARENT entitySetName
Child ::= CHILD entitySetName

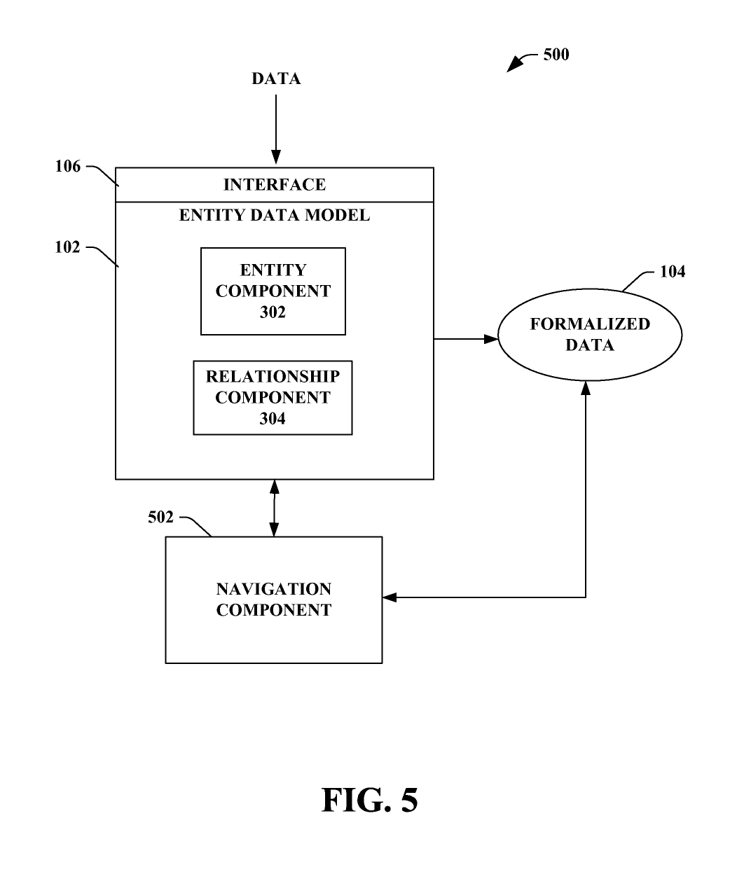

FIG. 5 illustrates a system 500 that facilitates navigating formalized data associated with an entity data model. The entity data model 102 enables RelationshipTypes, Relationship instances, and RelationshipSets to be formalized in a substantially similar fashion as EntityTypes, Entity instances, and EntitySets in order to reason about and manipulate such data without any foreign keys, link tables, and the like. The entity data model 102 addresses complex modeling needs by implementing inheritance, polymorphism, enables mechanisms for at least one of explicit and implicit relationships, recognition of the notion of entities and relationships, etc.

Furthermore, the system 500 can further include a navigation component 502 that facilitates navigating data related to the system 500. In particular, the navigation component 502 can explore data utilizing any suitable technique and/or mechanism (e.g., eSQL), wherein the navigation component 502 can expose RelationshipSets as first-class allowing simple navigation. Thus, utilizing the notion of the entity data model 102 formalizing RelationshipType data similarly to EntityType data, the navigation component 502 can browse such formalized data 104 without defining any joints, link tables, joint conditions, and the like. Rather, the navigation component 502 can utilize the natural properties of RelationshipType data (e.g., just as EntityType data) can be utilized to provide easy navigation based on the similar treatment and formalization of RelationshipType data and EntityType data.

Navigation properties are pseudo-properties on entities that describe the ends of a relationship. Standard- properties describe a value associated with an entity, while pseudo-properties describe a navigation-path over a relationship. For example, given a relationship between Customer and Order entities, an Order entity-type may describe a navigation property “OrderedBy” that represents the Customer-instance associated with that particular Order-instance.

The datatype of a navigation property can be Ref<T> and has the same multiplicity as the associated relationship end. For example, assuming a 1-n relationship between Customer and Order, a navigation property “OrderedBy” on the Order entity would have type Ref<Customer>. The following example describes the creation of a Navigation property:

```
<EntityType Name=“Customer” Key=“CustomerId”>
  ...
  <NavigationProperty name=”Orders”
RelationshipType=CustomerOrderType”
                toRole=”Orders” />
</EntityType>
<EntityType Name=“Order” Key=“OrderId”>
    ...
  <NavigationProperty name=”OrderedBy”
      RelationshipType=”CustomerOrderType” fromRole=”Order”
toRole=”Customer” />
</EntityType>
<Association Name=”CustomerOrderType”>
  <End Type=”Customer” Multiplicity=”1” Role=”Customer” />
  <End Type=”Order” Multiplicity=”*” Role=”Orders” />
</Association>
<!-- Alternative syntax for NavigationProperty →
<NavigationProperty Name=”Orders”
RelationshipType=”CustomerOrderType”
            fromRole=”Customer” toRole=”Orders” />
<NavigationProperty Name=”OrderedBy”
RelationshipType=”CustomerOrderType”
            fromRole=”Orders” toRole=”Customer” />
```

The abstract syntax for describing Navigation property is shown below:

NavigationProperty::= NAVIGATIONPROPERTY NAME propertyName
RELATIONSHIPTYPE relationshipName [FROMROLE role] TOROLE
role

The system 500 can further employ inheritance properties in connection with RelationshipType data and/or EntityType data. Inheritance is a fundamental modeling concept that allows different types to be related in a “Is a” relationship enabling extensibility and reuse of existing types. When type A inherits from type B, we say B is the base-type of A and A is a sub-type or derived-type of B. The derived-type inherits all properties of its base-type and these properties are called inherited-properties. The derived-type can be extended to have more properties and these additional properties are called direct-properties. The direct-property name may be the same as its inherited-property name in which case the direct-property has to be qualified with the new modifier. The name collision does not result in an ambiguity as based on the type of the instance at the point of access it resolves to either the direct or inherited-property. All valid derived-type instances at all times are also valid base type instances and can be substituted for the parent instance.

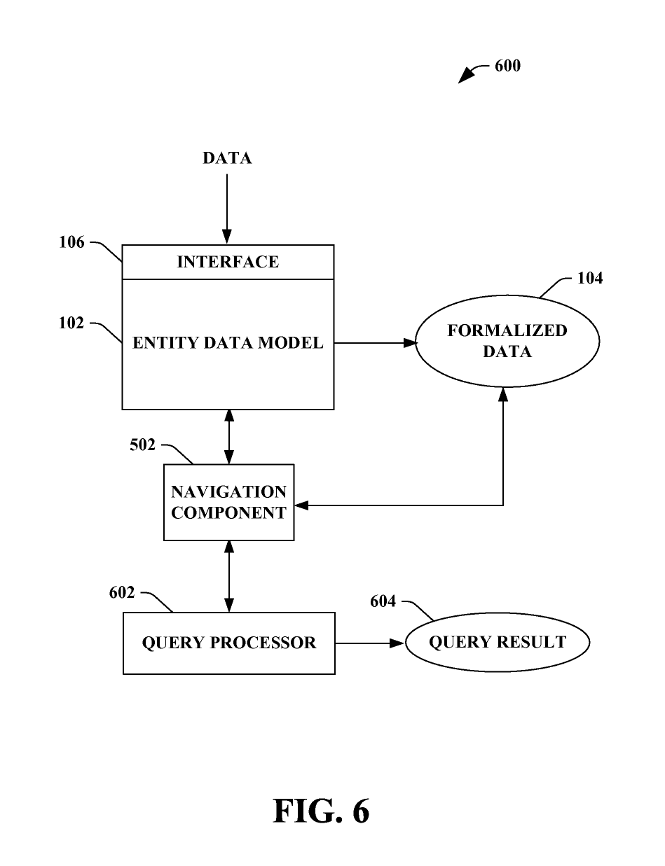

FIG. 6 illustrates a system 600 that facilitates querying formalized data utilizing a query processor to provide a query result. The entity data model 102 elevates relationships to be first-class constructs in the data model. Relationships can be established between two or more entity types, and users can navigate over the relationship from one end (entity) to another.

The general form of these navigation constructs is navigate (instance-expression, relationship-type, to-end, from-end). For example:
Select o.Id, navigate(o, OrderCustomer, Customer, Order) From Orders as o
   where OrderCustomer is the name of the relationship, and Customer and Order are the names of the to-end (customer) and from-end (order) of the relationship. If OrderCustomer was a n:1 relationship, then the result type of the navigate expression is Ref<Customer>. Similarly, in a query of the form:
Select c.Id, navigate(c, OrderCustomer, Order, Customer) From Customers as c

### The navigate expression would produce a Collection<Ref<Order>> and the instance-expression can be an entity/ref type.

In general, it is to be appreciated that the formalized data 104 allows any suitable query processor 602 to implement data operations therewith. In other words, the system 600 provides a pluggable architecture for a query processor that allows data to be queried locally, remotely, over a wire, etc. regardless of programming language and/or format. For instance, the system 600 allows a formalization of data (e.g. RelationshipType data similar to EntityType data) to be created, than allow such data to be queried remotely to provide a query result 604. Moreover, such data can be queried in a remote location the same as querying data in the memory of a local computer.

Thus, upon the creation of the formalized data 104, the query processor 602 can be implemented to provide a query result 604. It is to be appreciated that the entity data model can formalize the RelationshipType data in a manner similar to EntityType data such that navigation is optimized and such that any suitable query processor 604 can query the formalized data 104. In other words, the system 600 can be pluggable with any suitable query processor to provide a query result.

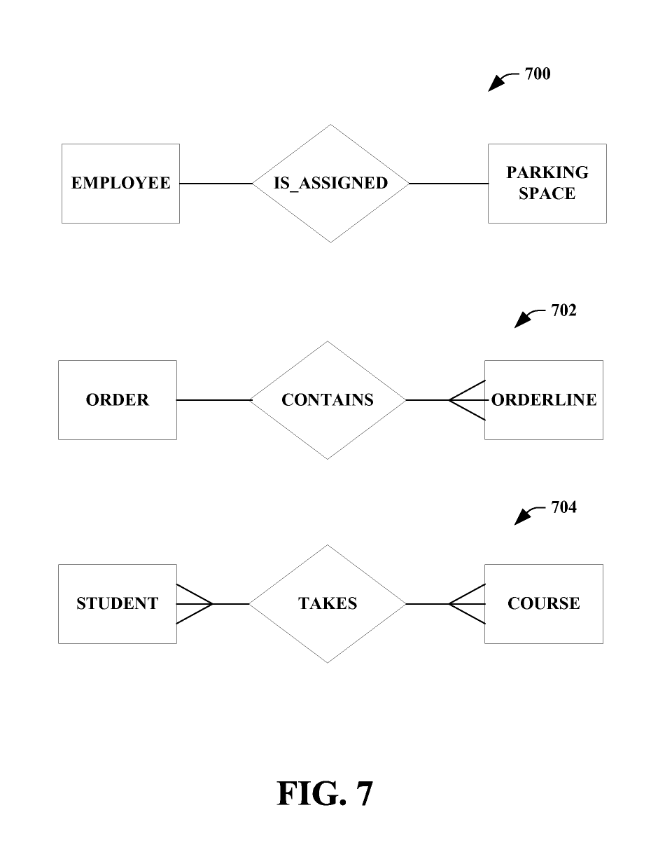

FIG. 7 illustrates a type structure 700 describing the various cardinalities of type instances in accordance with the claimed subject matter. The multiplicity of a relationship describes the cardinality or number of instances of an EntityType that can be associated with the instances of another EntityType. The basic types of multiplicity are: one-one, one-many and many-many. For instance, a binary relationship 700 is illustrated that is a one-to-one relationship multiplicity. A disparate binary relationship 702 is depicted that is a one-to-many relationship multiplicity. Moreover, a binary relationship 704 represents a many-to-many relationship multiplicity. It is to be appreciated that multiplicity can be related to EntityType data as well (e.g. since RelationshipType data can be formalized in a manner analogous to EntityType data). Thus, the notion of multiplicity describes the cardinality of a property. Entity properties can be either single or multi-valued. The value “1” denotes single-valued and “*” denotes multi-valued properties where the default is “1”. The collection semantics for the multi-valued property is that of a bag or multi-set, the individual items in a multi-valued property are un-ordered and may have duplicates.

A one-many is a special case of many-many and one-one is a special case of one-to-many relationship. Similarly, cardinality or zero (implying that it's optional) can be seen as a special case of the above relationships. For instance, 0 or 1 to many is a special case of 1 to many. The example shown below shows the usage of multiplicity in a relationship:

```
<Association Name=”CustomerOrder”>
  <End Type=”Customer” Multiplicity=”1”>
  <End Type=”Order” Multiplicity=”*”>
    <OnDelete Action=”Cascade” />
  </End>
</Association>
```

The “Multiplicity” facet defines the cardinality of a relationship end. In this example, there is exactly one Customer (value is “1” on line 2) for zero or more Order instances (value is “*” on line 3). Other values for this facet are:
“0..1”—zero or one
“1”—exactly one
“*”—zero or more
“1..*”—one or more
* “n”—exactly n
* “n..m”—between n and m, inclusive, where n is less than or equal to m.

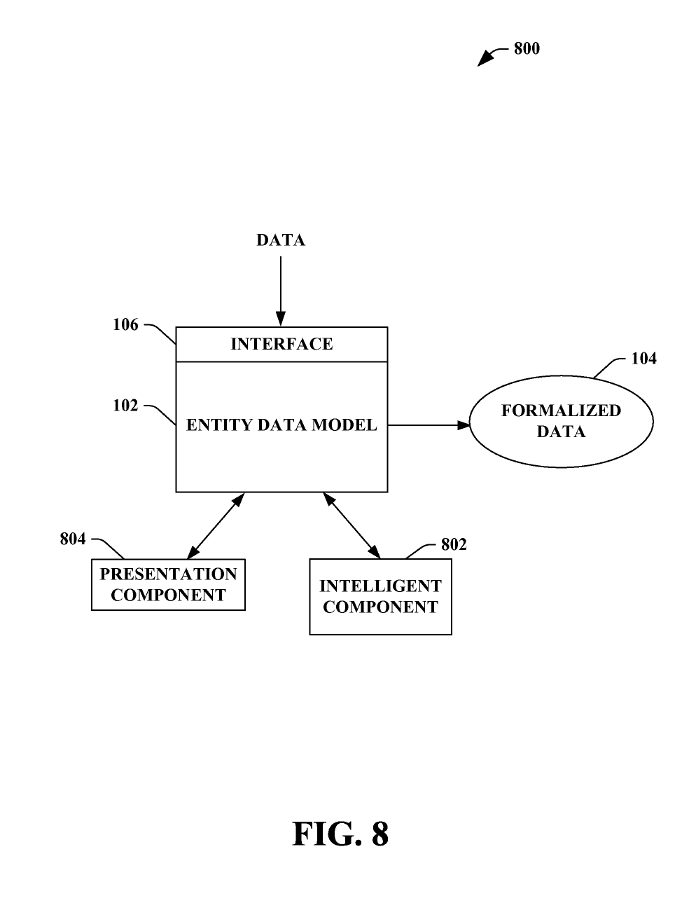

FIG. 8 illustrates a system 800 that facilitates formalizing the notion of at least one of a Relationship type, a Relationship instance, and a RelationshipSet. The system 800 can include the entity data model 102, the formalized data 104, and the interface 106, that can all be substantially similar to respective components, models, and interfaces as described in previous figures. The system 800 further includes an intelligent component 802. The intelligent component 802 can be utilized by the entity data model 102 to facilitate formalizing data.

It is to be understood that the intelligent component 802 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The entity data model 102 can further utilize a presentation component 804 that provides various types of user interfaces to facilitate interaction between a user and any component coupled to the entity data model 102. As depicted, the presentation component 804 is a separate entity that can be utilized with the entity data model 102. However, it is to be appreciated that the presentation component 804 and/or similar view components can be incorporated into the entity data model 102 and/or a stand-alone unit. The presentation component 804 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the entity data model 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

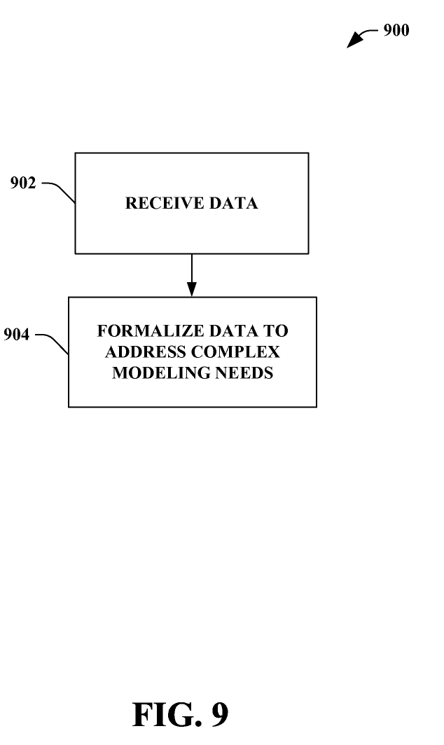

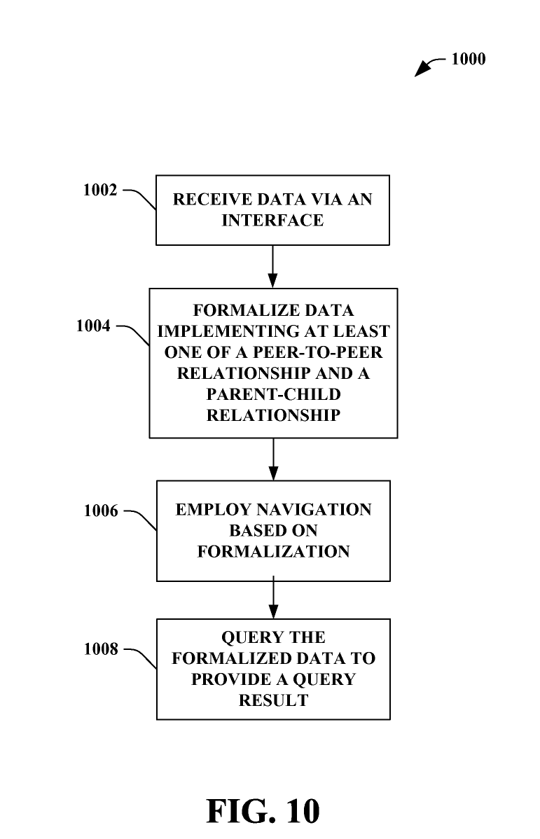

FIGS. 9-10 illustrate methodologies in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 9 illustrates a methodology 900 for employing an entity data model that formalizes a Relationship type, a Relationship instance, and a RelationshipSet. At reference numeral 902, data can be received. The data can be, but is not limited to, any data related to an entity data model, a Relationship, a RelationshipType, RelationshipType data, any data related to a relationship, a RelationshipSet, a Relationship instance, an Entity, an EntityType, Entitytype data, any data related to an entity, an EntitySet, an Entity instance, etc. Moreover, the data can be associated with a wide range of applications such as Personal Information Management (PIM) applications, Line-of-Business applications, etc.

Entities describe real-world objects with independent existence, and are instances of Entity Types (e.g., Customer, Employee, book, shelf, keyboard, speaker, wall, house, street, globe, Earth, any suitable entity that can be a real-world object, etc.). Relationships are instances of Relationship Types, and express linkages between instances of two or more entity types (e.g. Employee WorksFor Department, where Employee is an entity type, Department is an entity type, and WorksFor is the Relationship type).

At reference numeral 904, the received data can be formalized in a manner that satisfies complex modeling needs. The data can be formalized in a manner that is analogous to EntityType data within data modeling constructs. In particular, RelationshipType data, Relationship instances, and RelationshipSets can be reasoned about and manipulated in a manner that is similar to EntityType data, Entity instances, and EntitySets. Thus, by providing the handling of relationship data similarly as entity data, the following can be employed: support for rich types (with inheritance and polymorphism) and relationships; allowing explicit and implicit relationships; and recognizes the distinct nature of an entity and a relationship.

Moreover, the treatment of RelationshipType data in a similar fashion as EntityType data facilitates navigation based on natural properties associated therewith without defining joints, link tables, joining conditions, etc. (e.g., discussed supra). Additionally, by utilizing a formalization technique similar to that of EntityType data for RelationshipType data, a foreign key, link table, etc. is not needed to reference, access, represent, model, and/or cross-reference such data.

FIG. 10 illustrates a methodology 1000 that facilitates formalizing RelationshipType data in a manner that is analogous to EntityType data. At reference numeral 1002, data can be received via an interface. At reference numeral 1004, the received data can be formalized implementing at least one of a peer-to-peer relationship and a parent-child relationship. In particular, the data can be formalized with a notion that RelationshipType data is handled with substantially similar techniques as EntityType data within the data modeling constructs. Specifically, the RelationshipType data can be peer-to-peer relationships (e.g. Association relationship) and/or parent-child relationships (e.g., Containment relationship).

At reference numeral 1006, navigation can be provided based at least in part upon the formalization. The navigation can explore data utilizing any suitable technique and/or mechanism (e.g., eSQL). Thus, utilizing the notion formalizing RelationshipType data similarly to EntityType data, formalized data can be browsed without defining any joints, link tables, joint conditions, and the like. Rather, the natural properties of RelationshipType data (e.g., just as EntityType data) can be utilized to provide easy navigation based on the similar treatment and formalization of RelationshipType data and EntityType data. At reference numeral 1008, based on the natural properties associated with the RelationshipType data, any suitable query processor can be utilized to provide at least one query result.

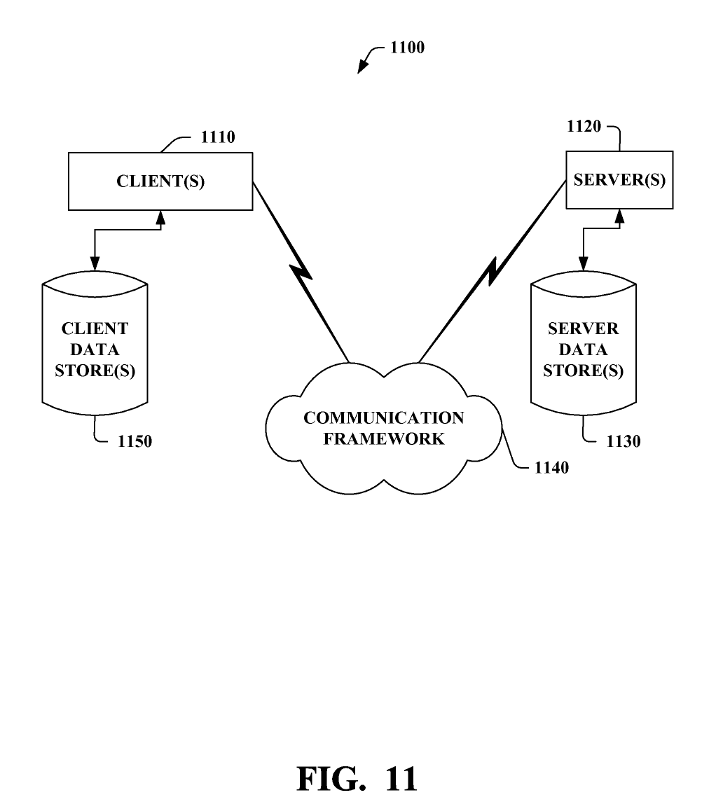

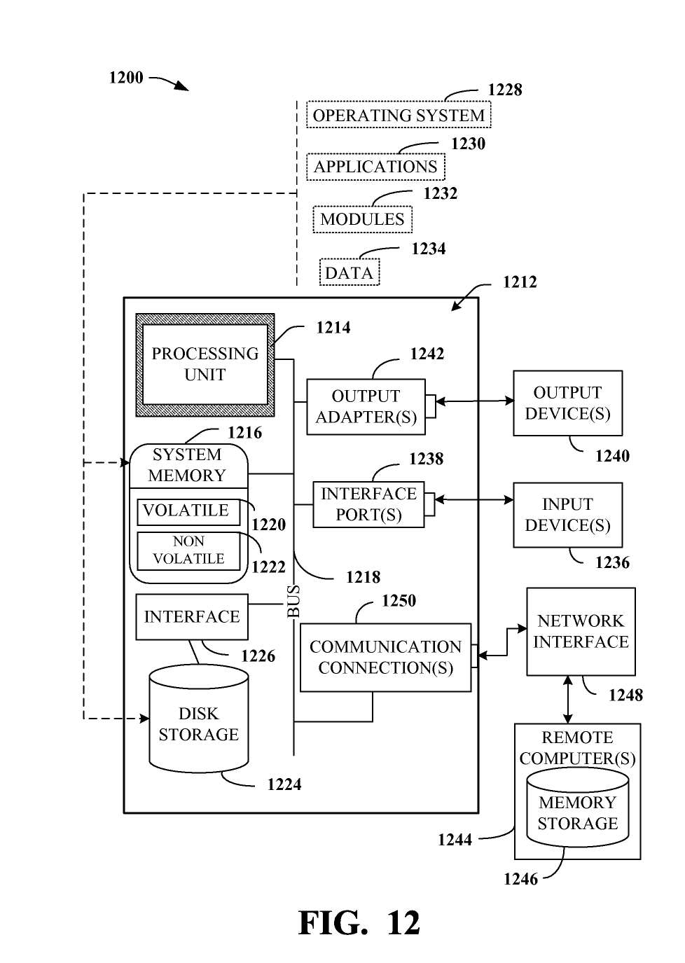

In order to provide additional context for implementing various aspects of the claimed subject matter, FIGS. 11-12 and the following discussion is intended to provide a brief, general description of a suitable computing environment in which the various aspects of the subject innovation may be implemented. For example, an entity data model that facilitates formalizing data, and in particular relationship types, relationship instances, and relationship sets, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 11 is a schematic block diagram of a sample-computing environment 1100 with which the claimed subject matter can interact. The system 1100 includes one or more client(s) 1110. The client(s) 1110 can be hardware and/or software (e.g., threads, processes, computing devices). The system 1100 also includes one or more server(s) 1120. The server(s) 1120 can be hardware and/or software (e.g., threads, processes, computing devices). The servers 1120 can house threads to perform transformations by employing the subject innovation, for example.

One possible communication between a client 1110 and a server 1120 can be in the form of a data packet adapted to be transmitted between two or more computer processes. The system 1100 includes a communication framework 1140 that can be employed to facilitate communications between the client(s) 1110 and the server(s) 1120. The client(s) 1110 are operably connected to one or more client data store(s) 1140 that can be employed to store information local to the client(s) 1110. Similarly, the server(s) 1120 are operably connected to one or more server data store(s) 1130 that can be employed to store information local to the servers 1120.

With reference to FIG. 12, an exemplary environment 1200 for implementing various aspects of the claimed subject matter includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1294), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable programmable ROM (EEPROM), or flash memory. Volatile memory 1220 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in the suitable operating environment 1200. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the claimed subject matter can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates addressing complex modeling, comprising:
an interface that receives data; and
an entity data model that formalizes a notion of at least one of a Relationship type, a Relationship instance, and a Relationship Set in a manner substantially similar to at least one of an Entity type, an Entity instance, and an entity-set respectively.

2. The system of claim 1, the formalized notion of at least one of the Relationship type, the Relationship instance, and the Relationship Set enables a mechanism for an explicit relationship and an implicit relationship.

3. The system of claim 1, the formalized notion of at least one of the Relationship type, the Relationship instance, and the Relationship Set is represented in a disparate manner in comparison to the Entity type, the Entity instance, and the entity-set respectively in order to allow the entity data model to recognize the notion and distinct nature between such data.

4. The system of claim 1, further comprising an association relationship that models and implements a peer-to-peer relationship between at least two entities.

5. The system of claim 1, further comprising a containment relationship that models and implements a parent-child relationship between at least two entities.

6. The system of claim 1, the entity is a real-world object with independent existence and is an instance of the entity type.

7. The system of claim 6, the entity-set is a collection of at least one entity of the same entity type.

8. The system of claim 1, the relationship is an instance of the relationship type and expresses a linkage between instances of two or more entity types.

9. The system of claim 8, the Relationship Set represents a collection of relationship instances of the same relationship type.

10. The system of claim 1, the entity data model supports at least one of rich entity and rich relationship with at least one of inheritance and polymorphism.

11. The system of claim 1, the entity data model reduces the impedance mismatch of at least one of the following: an application; a Personal Information Management (PIM) application; a Line-of-Business application; a service; a replication service; a synchronization service; a presentation service; a reporting service; a search service; and a security service.

12. The system of claim 1, the entity data model incorporates at least one of the Relationship type, Relationship instance, and Relationship Set as a first class concept in the model which allows the same status as at least one of an Entity type, Entity instance, and Entity set respectively, wherein a semantic associated with the at least one of relationship type, instance, and set is captured as metadata in the same manner as capturing metadata for at least one of the entity type, instance, and set respectively.

13. The system of claim 1, at least one of the Relationship type, the Relationship instance, and the Relationship Set includes a rich operation semantic associated therewith to enable a rich collection of at least one of a validation, an integrity constraint, and a rule to model a behavior associated with such relationships.

14. The system of claim 13, the entity data model provides at least one of the following: semantic constraint enforcement associated with at least one of an association relationship and a containment relationship; a navigation of a relationship in a first class manner; implement an efficient query describing navigation; and define a Relationship type that connects an entity at an end point of the relationship and at least one disparate relationship.

15. The system of claim 1, further comprising a database runtime system that implements the entity data model in a concrete manner, wherein the runtime includes at least one of the following: a mapping facility; a querying facility; and an updating facility that updates at least one of an entity and a relationship in a data source.

16. The system of claim 1, further comprising a navigation component that leverages a natural property related to the at least one of the at least one of the Relationship, the Relationship instance, and the Relationship Set to provide navigation without at least one of a joint definition, a link table and a joint condition.

17. A computer-implemented method that facilitates addressing complex modeling, comprising:
receiving Relationship Type data; and
formalizing Relationship Type data in a same manner as Entity Type data associated with a data modeling construct.

18. The method of claim 17, further comprising implementing at least one of a peer-to-peer relationship and a parent-child relationship.

19. The method of claim 17, further comprising:
employing navigation based on the formalization;
querying the formalized data; and
providing at least one query result.

20. A computer-implemented system that facilitates addressing complex modeling, comprising:
means for receiving data; and
means for formalizing a notion of at least one of a Relationship, a Relationship instance, and a Relationship Set in a manner substantially similar to at least one of an Entity type, an Entity instance, and an entity-set respectively, wherein a semantic related to the at least one of the Relationship, the Relationship instance, and the Relationship Set are captured as metadata in the same manner as metadata is captured for at least one of the Entity type, the Entity instance, and the Entity-set, respectively.
